(19) United States
(12) Patent Application Publication
(10) Pub. No.: US 2026/0162286 A1
(43) Pub. Date: Jun. 11, 2026

(54) INFORMATION PROCESSING DEVICE AND METHOD

(71) Applicant: SONY GROUP CORPORATION, TOKYO (JP)

(72) Inventor: KENJI TANAKA, TOKYO (JP)

(21) Appl. No.: 18/707,189

(22) PCT Filed: Oct. 25, 2022
(86) PCT No.: PCT/JP2022/039650

§ 371 Date: May 8, 2024

(30) Foreign Application Priority Data
Nov. 12, 2021 (JP) 2021-184748

(51) Int. Cl. G06T 7/55; H04N 13/117; H04N 13/156; H04N 21/81

(52) U.S. Cl. CPC G06T 7/55; H04N 13/117; H04N 13/156; H04N 21/816

(57) ABSTRACT

The present disclosure relates to an information processing device and method capable of more easily generating 3D information. Specifying a behind area that is invisible from a viewpoint position by an object in a three-dimensional area on the basis of depth information, specifying an object area where the object exists in the three-dimensional area by combining at least two of the behind areas specified on the basis of each of at least two pieces of the depth information, and generating a geometry of the object area using the at least two pieces of depth information; and generating an attribute of the object area using a captured image corresponding to the depth information. The present disclosure can be applied to, for example, an information processing device, an electronic device, an information processing method, an information processing system, a program, or the like.

### TECHNICAL FIELD

The present disclosure relates to an information processing device and method, and more particularly, to an information processing device and method capable of more easily generating 3D information.

### BACKGROUND ART

Conventionally, as 3D content that is content using 3D information representing an object existing in a three-dimensional space, there has been 6DoF content in which a viewpoint position, a line-of-sight direction, and the like of a 2D image for display can be arbitrarily set. Then, a method of generating such 6DoF content using captured images obtained by imaging a real space using a plurality of image sensors has been conceived (see, for example, Patent Document 1). Furthermore, a system has been considered in which the 6DoF content is generated as time-series data like a moving image, and the 6DoF content is reproduced in parallel with the generation of the 6DoF content.

### CITATION LIST

### Patent Document

Patent Document 1: Japanese Patent Application Laid-Open No. 2018-055644

### SUMMARY OF THE INVENTION

### Problems to be Solved by the Invention

However, in the conventional method, a large number of captured images (that is, a large number of image sensors) are required in order to generate 3D information with sufficient accuracy. Therefore, there is a possibility that the cost required for generating 3D information with sufficient accuracy increases.

The present disclosure has been made in view of such a situation, and an object thereof is to more easily generate 3D information.

### Solutions to Problems

An information processing device according to an aspect of the present technology includes: a geometry generation unit that specifies a behind area that is invisible from a viewpoint position by an object in a three-dimensional area on the basis of depth information, specifies an object area where the object exists in the three-dimensional area by combining at least two of the behind areas specified on the basis of each of at least two pieces of the depth information, and generates a geometry of the object area using the at least two pieces of depth information; and an attribute generation unit that generates an attribute of the object area using a captured image corresponding to the depth information.

An information processing method according to an aspect of the present technology includes: specifying a behind area that is invisible from a viewpoint position by an object in a three-dimensional area on the basis of depth information, specifying an object area where the object exists in the three-dimensional area by combining at least two of the behind areas specified on the basis of each of at least two pieces of the depth information, and generating a geometry of the object area using the at least two pieces of depth information; and
generating an attribute of the object area using a captured image corresponding to the depth information.

In the information processing device and the method according to one aspect of the present technology, a behind area invisible from a viewpoint position by an object in a three-dimensional area is specified on the basis of depth information, an object area where the object exists in the three-dimensional area is specified by combining at least two behind areas specified on the basis of each of at least two pieces of depth information, a geometry of the object area is generated using the at least two pieces of depth information, and an attribute of the object area is generated using a captured image corresponding to the depth information.

### BRIEF DESCRIPTION OF DRAWINGS

FIG. 1 is a block diagram illustrating a main configuration example of an information processing system.

FIG. 2 is a diagram illustrating an arrangement example of a depth sensor and an image sensor.

FIG. 3 is a diagram illustrating an example of depth information and a captured image.

FIG. 4 is a diagram illustrating an example of depth information and a captured image.

FIG. 5 is a diagram illustrating an example of depth information and a captured image.

FIG. 6 is a diagram illustrating an example of a state of setting a behind area.

FIG. 7 is a diagram illustrating an example of a state of specifying an object area.

FIG. 8 is a diagram illustrating an example of how an object area is specified in voxel units.

FIG. 9 is a diagram illustrating an example of geometry.

FIG. 10 is a diagram illustrating an example of a state of attribute generation.

FIG. 11 is a diagram illustrating an example of a flow of 3D information generation for each frame.

FIG. 12 is a diagram illustrating an example of a state of reproduction.

FIG. 13 is a flowchart illustrating an example of a processing flow of an entire information processing system.

FIG. 14 is a block diagram illustrating a main configuration example of an information processing system.

FIG. 15 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Generation of 6DoF content
2. First embodiment (information processing system)
3. Second embodiment (information processing system)
4. Appendix

### 1. Generation of 6DoF Content

### Documents and the Like That Support Technical Contents and Technical Terms

The scope disclosed in the present technology includes, in addition to the contents disclosed in the embodiments, contents described in following Non-Patent Documents and the like known at the time of filing, the contents of other documents referred to in following Non-Patent Documents and the like.

Patent Document 1: (described above)

That is, the contents described in the above-described Non-Patent Documents, the contents of other documents referred to in the above-described Non-Patent Documents, and the like are also basis for determining the support requirement.

### Generation of 6DoF Content Using Captured Image

Conventionally, for example, there is 3D information representing an object existing in a three-dimensional space, such as a point cloud or a paligon, and the like. A point cloud represents a shape of an object existing in a three-dimensional space as a set of points. Data of the point cloud includes geometry (position information) and an attribute (attribute information) of each point. The polygon represents a surface shape of an object existing in a three-dimensional space by a polygonal surface.

There has been 3D content which is content using such 3D information. That is, in the 3D content, 3D information is provided as content. For example, the display device renders the supplied 3D information to generate a 2D image, and displays the 2D image on a monitor or the like. That is, in this case, a 2D image in a case where an object or the like existing in the three-dimensional space is viewed from a certain viewpoint is provided to the user.

As such 3D content, there is 6DoF content in which a viewpoint position, a line-of-sight direction, and the like of the 2D image to be displayed can be arbitrarily set. That is, in the 6DoF content, a 2D image such as a free viewpoint position and a line-of-sight direction can be provided to the user. Then, a system that generates three-dimensional information using a captured image obtained by capturing a real space and provides the three-dimensional information as 6DoF content has been conceived. For example, a plurality of cameras arranged in the real space images the real space to generate captured images. Then, the information processing device generates the 3D information using the plurality of captured images obtained in this manner. Then, a server or the like provides the 3D information to a client as 6DoF content. The client renders the provided 3D information, for example, generates and displays a 2D image of an arbitrary viewpoint specified by a user or the like.

Furthermore, a system in which such 6DoF content is generated and provided immediately (in real time) has been conceived. That is, in this case, the information processing device generates the 3D information as time-series data like a moving image. The server sequentially provides the generated 3D information of each frame (time) as 6DoF content. The client renders the 3D information for each frame and displays a 2D image. That is, in this case, the 2D image is displayed as a moving image.

Therefore, in the case of this system, acquisition and rendering of a 3D image, and display of a 2D information (moving image), and the like by the client can be performed in parallel with the generation of the 3D information. In other words, the information processing device is required to generate the 3D information at a speed that does not cause a failure of the 2D image display (moving image display) by the client.

However, in a case where 3D information is generated from a plurality of captured images in this manner, in order to obtain sufficiently highly accurate 3D information, there has been a need to capture an image of a real space using a large number of cameras, for example, several tens or more cameras. In other words, there has been a possibility that if the number of cameras is not sufficient, the accuracy of the 3D information is reduced. For example, there has been a possibility that an angle difference between imaging directions between the captured images is too large so that the accuracy of modeling a three-dimensional shape is reduced, and a shape of the object in the 3D information is distorted.

Therefore, in order to obtain sufficiently highly accurate 3D information, there has been a possibility that the cost required for imaging the real space increases. For example, as the number of required imaging devices increases, there has been a possibility that the cost of purchasing, renting the imaging devices to be prepared, and the like increases. In addition, there has been a possibility that power consumption increases. Furthermore, it is necessary to perform imaging in a place where a large number of imaging devices can be installed, and for example, there has been a possibility that the cost for securing a place having a sufficient size and sufficient equipment (power supply or the like) increases.

Furthermore, in order to obtain sufficiently highly accurate 3D information, calibration between imaging devices has been required. The number of imaging devices increases, and then the difficulty of this calibration also increases, and thus, there has been a possibility that the cost increases. For example, there has been a possibility that a staff who performs calibration is required to have advanced technical proficiency. In addition, there has been a possibility that the number of staff members required for calibration also increases. Therefore, there has been a risk that the employment cost of the staff increases. Furthermore, there has been also a possibility that the calibration processing time increases.

In addition, as the number of cameras increases, the number of captured images used for generating 3D information also increases, and thus there has been a risk that the load of 3D information generation processing increases. The processing load increases, and then there has been a possibility that the processing time increases. Therefore, there has been a possibility that a processing capability required for the information processing device that generates the 3D information increases in order to prevent the client processing and the like from collapsing. That is, there is a possibility that the cost of the information processing device increases in order to generate sufficiently highly accurate 3D information. For example, as the information processing device, more high-performance hardware (for example, a higher performance processor, a larger capacity memory, or the like) is required, and there has been a possibility that a possibility that the cost for purchasing, manufacturing, and the like of the hardware increases. In addition, there has been a possibility that the power consumption of the information processing device increases.

As described above, in the conventional method, there has been a possibility that the cost required for generating 3D information with sufficient accuracy increases.

### Generation of 6DoF Content Using Depth Information and Captured Image

Therefore, the depth is also detected in the real space, and the 3D information is generated using not only the captured image but also the depth information.

For example, an information processing device includes: a geometry generation unit that specifies a behind area invisible from a viewpoint position by an object in a three-dimensional area on the basis of depth information, specifies an object area where the object exists in the three-dimensional area by combining at least two behind areas specified on the basis of each of at least two pieces of depth information, and generates a geometry of the object area using the at least two pieces of depth information; and an attribute generation unit that generates an attribute of the object area using a captured image corresponding to the depth information.

For example, the information processing method performs specifying a behind area that is invisible from a viewpoint position by an object in a three-dimensional area on the basis of depth information, specifying an object area where the object exists in the three-dimensional area by combining at least two of the behind areas specified on the basis of each of at least two pieces of the depth information, and generating a geometry of the object area using the at least two pieces of depth information; and generating an attribute of the object area using a captured image corresponding to the depth information.

With the above processing, the 3D information can be more easily generated.

2. First Embodiment

### Information Processing System

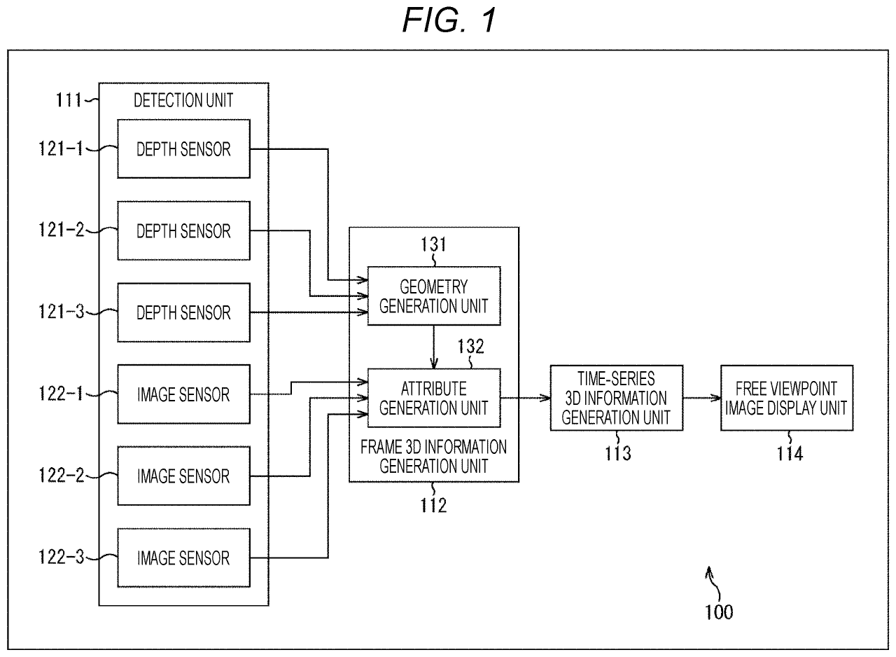

FIG. 1 is a block diagram illustrating an example of a configuration of an information processing system to which the present technology is applied. An information processing system 100 illustrated in FIG. 1 is a system that acquires information from a real space, generates 6DoF content on the basis of the information, and provides and reproduces the 6DoF content. The above-described present technology can be applied to the information processing system 100.

Note that FIG. 1 illustrates main components such as a device, a processing unit, and a flow of data, and the components illustrated in FIG. 1 are not necessarily all components. That is, in the information processing system 100, there may be a device or a processing unit not illustrated as a block in FIG. 1, or there may be a process or a data flow not illustrated as an arrow or the like in FIG. 1.

As illustrated in FIG. 1, the information processing system 100 includes a detection unit 111, a frame 3D information generation unit 112, a time-series 3D information generation unit 113, and a free viewpoint image display unit 114.

### Detection Unit

The detection unit 111 is a processing unit that detects desired information in a real space. The detection unit 111 generates depth information and a captured image as the information, and supplies the depth information and the captured image to the frame 3D information generation unit 112. The detection unit 111 includes a depth sensor 121-1, a depth sensor 121-2, a depth sensor 121-3, an image sensor 122-1, an image sensor 122-2, and an image sensor 122-3.

In a case where there is no need to distinguish the depth sensor 121-1 to the depth sensor 121-3 from each other in the description, those depth sensors are also referred to as the depth sensor 121. The depth sensor 121 (That is, each of the depth sensor 121-1 to the depth sensor 121-3) is a sensor that measures (detects) a distance (depth) to an object in a real space. A method of measuring this distance is arbitrary. For example, a time-of-flight (ToF) method may be used. The TOF method is a method of emitting light (for example, infrared light) from a light emitting source toward an object in a real space, receiving reflected light thereof, deriving a time (flight time) from light emission to light reception, and deriving a distance to the object on the basis of the flight time. Of course, the depth sensor 121 may measure the distance by a method other than the ToF method, but in the present specification, as an example, the depth sensor 121 measures the distance by the ToF method. Furthermore, the distance from the depth sensor 121 to the object is also referred to as depth. In this manner, the depth sensor 121 detects the depth in a predetermined range of the real space, and generates depth information configured by the depth of the range. In other words, the depth sensor 121 is a depth detection unit that generates depth information by measuring a distance in a three-dimensional area.

Note that the number of depth sensors 121 included in the detection unit 111 is arbitrary as long as it is plural (two or more). That is, although three depth sensors 121 are illustrated in FIG. 1, the number of depth sensors 121 may be two or four or more. In other words, the detection unit 111 includes at least two depth sensors 121.

The image sensors 122-1 to 122-3 will also be referred to as image sensors 122 in a case where there is no need to distinguish the image sensors from each other for description. The image sensor 122 (that is, each of the image sensor 122-1 to the image sensor 122-3) is a sensor that images a subject in the real space. That is, the image sensor 122 detects visible light in a predetermined range of the real space and generates a captured image in the range. In other words, the image sensor 122 is an imaging unit that generates a captured image by imaging a subject in a three-dimensional area.

Note that the number of the image sensors 122 included in the detection unit 111 is arbitrary as long as it is plural (two or more). That is, although three image sensors 122 are illustrated in FIG. 1, the number of image sensors 122 may be two or four or; more. In other words, the detection unit 111 includes at least two image sensors 122. The number of depth sensors 121 and the number of image sensors 122 may be the same as or different from each other.

All the sensors (the depth sensor 121 and the image sensor 122) may operate in synchronization with each other, and may obtain the depth information or the captured image at the same time. Each depth information and each captured image do not have to be information at the same time, but since the depth information and the captured images are information at the same time, robustness against the motion of the object can be improved. Note that, in the present specification, it is assumed that all the sensors (the depth sensor 121 and the image sensor 122) operate in synchronization with each other and obtain the depth information or the captured image at the same time.

It is assumed that the depth sensor 121 and the image sensor 122 are correctly calibrated. The calibration method is arbitrary. For example, a method using markers available in Open Source Computer Vision Library (OpenCV) or the like may be applied to estimate camera distortion and internal parameters. Furthermore, for the estimation of the camera's external parameters, that is, the position and attitude of the camera with respect to the world coordinates, a plurality of methods may be applied, and one of the methods giving higher accuracy may be selected. For example, any one of a method using markers available in OpenCV or the like and an ICP (Iterative Closest Point), which is a method for determining a relative positional relationship of cameras by fitting point cloud data generated for each device to each other may be selected.

The image sensor 122 can image an arbitrary range (area) of the real space. In other words, the position and orientation (imaging direction) of the image sensor 122 are arbitrary. However, the range is different for each image sensor 122. That is, each image sensor 122 images different ranges (areas) in the real space. Therefore, the captured images obtained by the image sensors 122 are different from each other in the range (area) of the real space as a subject. In other words, at least one of the position and orientation (imaging direction) of each image sensor 122 is different from those of the other image sensors 122. Note that the angle of view of the captured image generated by each image sensor 122 may not be the same (an angle of view of at least one image sensor 122 may be different from an angle of view of another image sensor 122.).

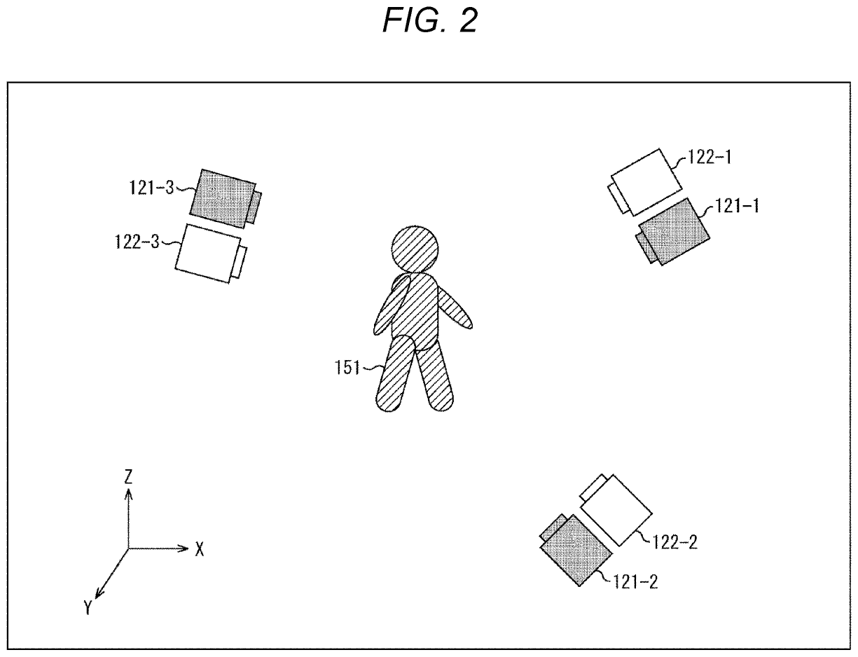

However, it is preferable to arrange each image sensor 122 so as to further reduce the blind spot (ideally, there is no blind spot) for the target object for which the 3D information is generated in the captured image group. That is, each image sensor 122 is preferably arranged such that a wider range of the surface of the object can be imaged (ideally, the entire surface of the object can be imaged) by the image sensors 122-1 to 122-3. For example, as illustrated in FIG. 2, the image sensors 122-1 to 122-3 may be arranged so as to surround an object 151 (a target for generating 3D information) in the real space.

The depth sensor 121 can detect a depth of an arbitrary range (area) of the real space. In other words, the position and direction (direction of distance measurement) of the depth sensor 121 are arbitrary. However, the range is different for each depth sensor 121. That is, each depth sensor 121 detects the depth in different ranges (areas) of the real space. Therefore, the depth information obtained by each depth sensor 121 is different from each other in the range (area) of the real space to be a distance measurement target. In other words, at least one of the position and orientation (distance measurement direction) of each depth sensor 121 is different from those of the other depth sensors 121. Note that the angle of view of the depth information generated by each depth sensor 121 (the size and shape of the distance measurement target range) may not be the same (an angle of view of at least one depth sensor 121 may be different from an angle of view of another depth sensor 121).

However, it is preferable to arrange each depth sensor 121 so as to further reduce the blind spot (ideally, there is no blind spot) for the object for which the 3D information is generated in the depth information group. That is, it is preferable to arrange each depth sensor 121 so that the depth sensor 121-1 to the depth sensor 121-3 can measure the distance to a wider range of the surface of the object (ideally, measure the distance to the entire surface of the object). For example, as illustrated in FIG. 2, the depth sensor 121-1 to the depth sensor 121-3 may be arranged so as to surround the object 151 (target for generating 3D information) in the real space.

However, the depth information corresponds to the captured images different from each other, and the range of each depth information includes at least the range of the corresponding captured image. That is, there is a pixel (depth) of the depth information corresponding to each pixel of the captured image, and the depth of the subject of each pixel of the captured image is obtained. The depth sensor 121 and the image sensor 122 are arranged so as to satisfy such conditions.

For example, as illustrated in FIG. 2, the positions and orientations of the depth sensor 121-1 and the image sensor 122-1 may be approximated to each other. That is, the depth sensor 121-1 and the image sensor 122-1 may be arranged so as to capture images or measure distances in directions approximate to each other from positions in the vicinity of each other. Similarly, the positions and orientations of the depth sensor 121-2 and the image sensor 122-2 may be approximated to each other. The positions and orientations of the depth sensor 121-3 and the image sensor 122-3 may be approximated to each other.

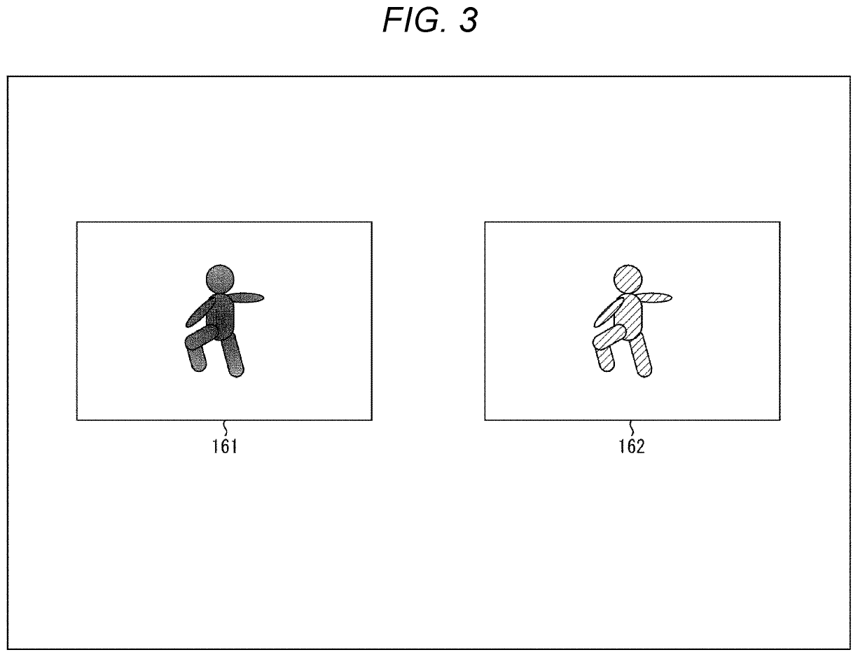

The depth information 161 illustrated in FIG. 3 illustrates an example of the depth information obtained by the depth sensor 121-1 of the example of FIG. 2. In the depth information, the depth is indicated as a pixel value in each pixel. That is, the depth from the depth sensor 121-1 to the object 151 is obtained by the depth information 161. In the depth information 161, the pixel value is indicated by shading. In practice, this shading will indicate the depth of each portion of the object 151. However, in FIG. 3, for convenience of description, the shading does not correspond to the depth of each portion of the object 151.

A captured image 162 illustrated in FIG. 3 illustrates an example of a captured image obtained by the image sensor 122-1 of the example of FIG. 2. The captured image 162 is a color image of visible light. That is, color information of the surface of the object 151 on the image sensor 122-1 side is obtained from the captured image 162. Note that, in the captured image 162, the object 151 is indicated by a diagonal line pattern, which schematically represents color information. In practice, the color information of each portion of the object 151 is expressed as a pixel value.

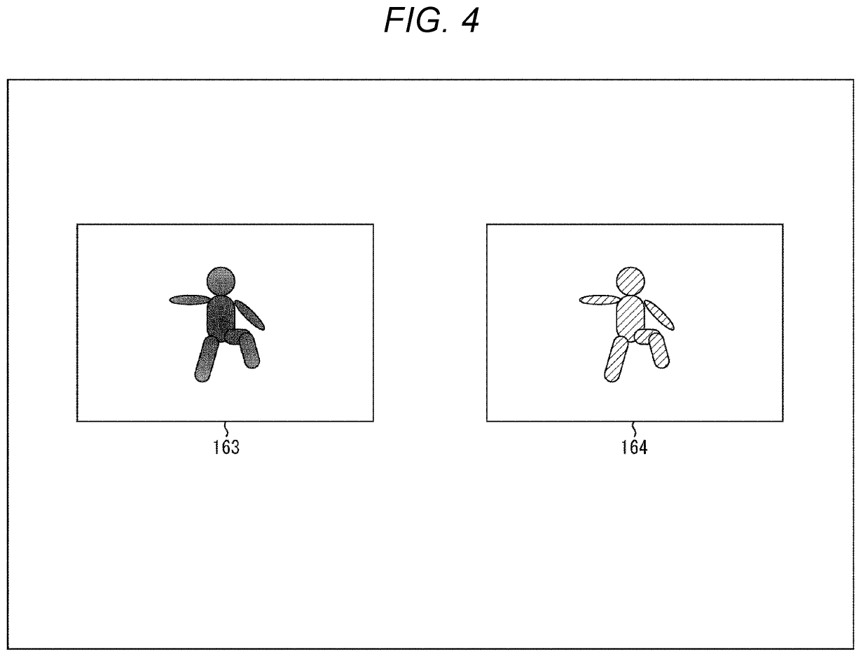

A depth information 163 illustrated in FIG. 4 illustrates an example of the depth information obtained by the depth sensor 121-2 of the example of FIG. 2. Similarly to the depth information 161, the depth information 163 also indicates the depth in each pixel as a pixel value. That is, the depth from the depth sensor 121-2 to the object 151 is obtained by the depth information 163. In the depth information 163, the pixel value is indicated by shading. In practice, this shading will indicate the depth of each portion of the object 151. However, in FIG. 4, for convenience of description, the shading does not correspond to the depth of each portion of the object 151.

A captured image 164 illustrated in FIG. 4 illustrates an example of a captured image obtained by the image sensor 122-2 of the example of FIG. 2. The captured image 164 is a color image of visible light similarly to the captured image 162. That is, color information of the surface of the object 151 on the image sensor 122-2 side is obtained from the captured image 164. Note that, in the captured image 164, the object 151 is indicated by a diagonal line pattern, which schematically represents color information. In practice, the color information of each portion of the object 151 is expressed as a pixel value.

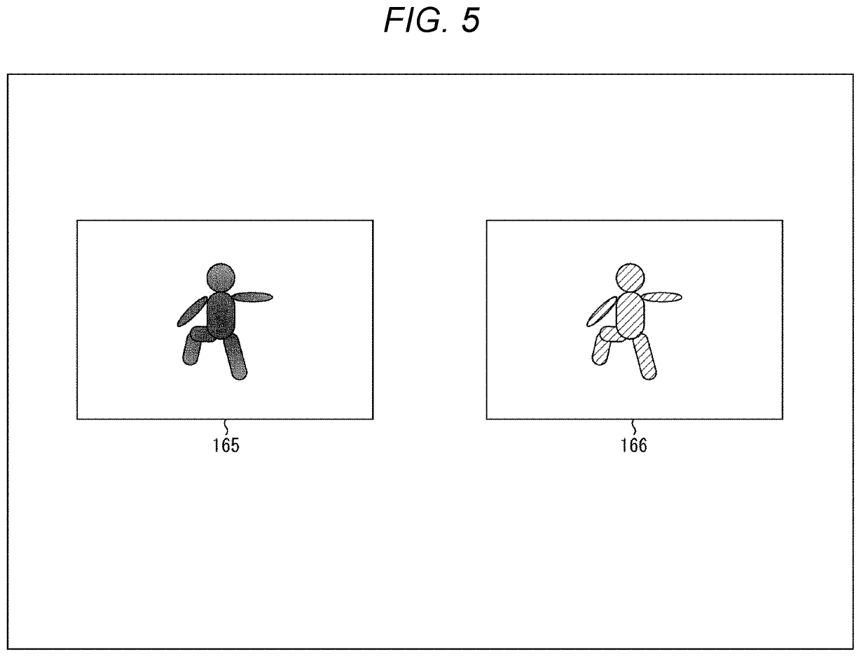

A depth information 165 illustrated in FIG. 5 illustrates an example of the depth information obtained by the depth sensor 121-3 of the example of FIG. 2. Similarly to the depth information 161, the depth information 165 also indicates the depth in each pixel as a pixel value. That is, the depth from the depth sensor 121-3 to the object 151 is obtained by the depth information 165. In the depth information 165, the pixel value is indicated by shading. In practice, this shading will indicate the depth of each portion of the object 151. However, in FIG. 5, for convenience of description, the shading does not correspond to the depth of each portion of the object 151.

A captured image 166 illustrated in FIG. 5 illustrates an example of a captured image obtained by the image sensor 122-3 of the example of FIG. 2. The captured image 166 is a color image of visible light similarly to the captured image 162. That is, color information of the surface of the object 151 on the image sensor 122-3 side is obtained from the captured image 166. Note that, in the captured image 166, the object 151 is indicated by a diagonal line pattern, which schematically represents color information. In practice, the color information of each portion of the object 151 is expressed as a pixel value.

The depth sensor 121 supplies the generated depth information to the frame 3D information generation unit 112 (geometry generation unit 131 as described later).

The depth sensor 121 may encode the generated depth information and supply the depth information as coded data to the frame 3D information generation unit 112 (geometry generation unit 131 as described later). This encoding method is arbitrary. For example, the depth sensor 121 may encode depth information by applying arithmetic encoding such as run length encoding and the like to generate coded data. With the above processing, the amount of data transmission from the detection unit 111 (depth sensor 121) to the frame 3D information generation unit 112 (geometry generation unit 131 described later) can be suppressed.

Furthermore, the depth sensor 121 may quantize the generated depth information and supply the quantized depth information to the frame 3D information generation unit 112 (geometry generation unit 131 described later). A method of the quantization is arbitrary. For example, a bit length of the depth may be reduced by limiting a range of the depth to be detected. For example, the depth of 16 bits may be changed to 8 bits by limiting the depth to be detected to a predetermined range such as 1 m to 4 m, and the like. With the above processing, the amount of data transmission from the detection unit 111 (depth sensor 121) to the frame 3D information generation unit 112 (geometry generation unit 131 as described later) can be suppressed.

Of course, the above-described encoding and quantization may be applied in combination. That is, the depth sensor 121 may quantize the generated depth information, further encode the quantized depth information, and supply the encoded depth information to the frame 3D information generation unit 112 (geometry generation unit 131 described later) as coded data. With the above processing, the amount of data transmission from the detection unit 111 (depth sensor 121) to the frame 3D information generation unit 112 (geometry generation unit 131 as described later) can be further suppressed.

The image sensor 122 supplies the generated captured image to the frame 3D information generation unit 112 (an attribute generation unit 132 as described later). Note that this captured image may be RAW data including an R component, a G component, and a B component, or may be RAW data subjected to development processing (image information including a luminance component and a color difference component).

The image sensor 122 may encode the generated captured image and supply the coded image to the frame 3D information generation unit 112 (an attribute generation unit 132 to be described later) as coded data. This encoding method is arbitrary. For example, the image sensor 122 may generate coded data (JPEG data) by encoding a captured image by applying a joint photographic experts group (JPEG) method. With the above processing, the amount of data transmission from the detection unit 111 (image sensor 122) to the frame 3D information generation unit 112 (attribute generation unit 132 to be described later) can be suppressed.

Note that the information detected by the detection unit 111 is arbitrary, and information other than the depth and visible light described above may also be detected and supplied to the frame 3D information generation unit 112. That is, the detection unit 111 supplies information detected in the real space including at least the depth information and the captured image to the frame 3D information generation unit 112. In other words, the detection unit 111 may further include other sensors (sensors that detect information other than depth and visible light) different from the depth sensor 121 and the image sensor 122.

### Frame 3D Information Generation Unit

The frame 3D information generation unit 112 in FIG. 1 is a processing unit that generates 3D information (3D information at a predetermined time) for each frame. The frame 3D information generation unit 112 acquires the information supplied from the detection unit 111. This information is optional, but includes at least depth information and a captured image. The frame 3D information generation unit 112 generates 3D information using the acquired information. Since the information supplied from the detection unit 111 is information in units of frames (that is, information at a certain time), the frame 3D information generation unit 112 generates 3D information for each frame (3D information at a predetermined time). The specification of the 3D information generated by the frame 3D information generation unit 112 is arbitrary. In the present specification, it is assumed that the frame 3D information generation unit 112 generates a point cloud as 3D information.

The frame 3D information generation unit 112 includes a geometry generation unit 131 and an attribute generation unit 132.

The geometry generation unit 131 performs processing related to generation of geometry that is position information on each point of a point cloud. For example, the geometry generation unit 131 acquires the depth information generated by each depth sensor 121. The geometry generation unit 131 generates the geometry of the point cloud using the acquired depth information. In other words, the geometry generation unit 131 may generate the geometry using at least two pieces of depth information generated by each of the at least two depth sensors 121.

Note that the depth information supplied from the depth sensor 121 may be encoded. That is, the geometry generation unit 131 may acquire the coded data of the depth information. In this case, the geometry generation unit 131 decodes the coded data and generates (restores) the depth information. Then, the geometry generation unit 131 generates geometry using the restored depth information. Note that this decoding method may be any method as long as the method compatible with the encoding method applied by the depth sensor 121. In other words, the geometry generation unit 131 decodes the coded data generated by each of the at least two depth sensors 121, and generates the geometry using the obtained at least two pieces of depth information.

Further, the depth information supplied from the depth sensor 121 may be quantized. In this case, the geometry generation unit 131 generates the geometry using the quantized depth information. In other words, the geometry generation unit 131 generates the geometry using the quantized depth information generated by each of the at least two depth sensors 121.

Of course, the depth information supplied from the depth sensor 121 may be quantized and encoded. That is, the geometry generation unit 131 may acquire coded data of quantized depth information. In this case, the geometry generation unit 131 decodes the coded data and generates (restores) quantized depth information. Then, the geometry generation unit 131 generates geometry using the quantized depth information.

The geometry generation unit 131 generates geometry as follows using the acquired at least two or more depth information.

First, in each acquired depth information, the geometry generation unit 131 divides a three-dimensional area of a depth detection target (that is, a distance measurement target range (area) in the real space) into a front area visible from a position (also referred to as a viewpoint position) of the depth sensor 121 that has generated the depth information and a behind area invisible. In other words, the geometry generation unit 131 specifies, on the basis of the depth information, the behind area that is invisible from the viewpoint position by the object in the three-dimensional area.

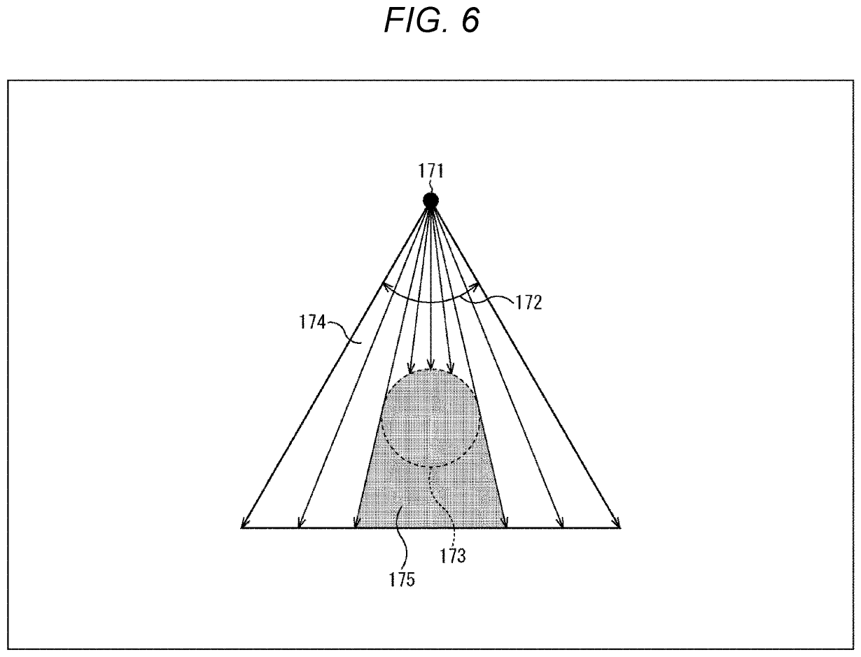

For example, in FIG. 6, it is assumed that the depth sensor 121 detects the depth from the viewpoint position 171 within a predetermined range indicated by a double-headed arrow 172. That is, the depth of each portion within this range is detected as indicated by arrows extending from the viewpoint position 171 in the drawing. Note that a maximum value is set for the depth. In the case of this example, the distance can be measured in a triangular area surrounded by two arrows contacting both ends of the double-headed arrow 172 and a bottom side in the drawing. Note that, in FIG. 6, for convenience of description, description will be made on a two-dimensional plane, but actually, a depth in a predetermined range is detected in the real space (three-dimensional area).

An object 173 exists in this area, and then an area visible from the viewpoint position 171 and an invisible area (an area hidden by the object 173) are formed. In the present specification, an area viewed from the viewpoint position 171 (in the drawing, a white area) is also referred to as a front area 174. Furthermore, an area (gray area in the figure) invisible from the viewpoint position 171 is also referred to as a behind area 175. In each acquired depth information, the geometry generation unit 131 divides the range of the depth detection target of the three-dimensional area into such front area 174 and behind area 175. For example, in a case where the depth is smaller than a maximum value, the geometry generation unit 131 can estimate that the object 173 exists therein and a back side of the depth is the behind area 175.

The geometry generation unit 131 specifies the behind area 175 based on such depth information for each of the acquired depth information. That is, in the case of the example of FIG. 1, the geometry generation unit 131 specifies the behind area 175 for each of the three pieces of depth information generated by the depth sensor 121-1 to the depth sensor 121-3.

Next, the geometry generation unit 131 combines the behind areas 175 specified for two or more pieces of depth information in the three-dimensional area to specify the object area where the object 173 exists. In other words, the geometry generation unit 131 specifies an object area where an object is present in the three-dimensional area by combining at least two behind areas 175 specified on the basis of each of at least two pieces of depth information.

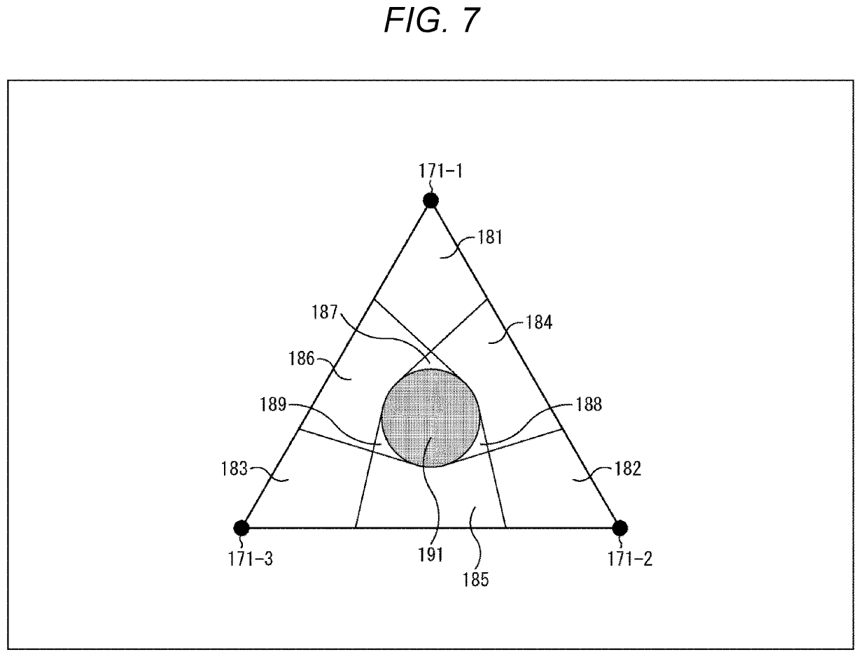

For example, depth detection target ranges of three pieces of depth information generated by the depth sensor 121-1 to the depth sensor 121-3 are arranged in a three-dimensional area, and then it is assumed that a combination result thereof is a triangle as illustrated in FIG. 7. In the example of FIG. 7, a viewpoint position 171-1 indicates a position of the depth sensor 121-1. A viewpoint position 171-2 indicates a position of depth sensor 121-2. A viewpoint position 171-3 indicates a position of depth sensor 121-3. Then, the depth detection target ranges of the depth sensors 121 completely coincide with each other in the three-dimensional area.

In FIG. 7, areas 181 to 189 are partial areas of the depth detection target range. The area 181 is a front area in each depth information generated by the depth sensor 121-1 to the depth sensor 121-3. Similarly, the area 182 and the area 183 are front areas in each of depth information generated by the depth sensor 121-1 to the depth sensor 121-3.

The area 184 is a front area in each depth information generated by the depth sensor 121-1 and the depth sensor 121-2, and is a behind area in the depth information generated by the depth sensor 121-3. Similarly, the area 185 is a front area in each depth information generated by the depth sensor 121-2 and the depth sensor 121-3, and is a behind area in the depth information generated by the depth sensor 121-1. In addition, the area 186 is a front area in each depth information generated by the depth sensor 121-1 and the depth sensor 121-3, and is a behind area in the depth information generated by the depth sensor 121-2.

The area 187 is a front area in each depth information generated by the depth sensor 121-1, and is a behind area in the depth information generated by the depth sensor 121-2 and the depth sensor 121-3. Similarly, the area 188 is a front area in each depth information generated by the depth sensor 121-2, and is a behind area in the depth information generated by the depth sensor 121-1 and the depth sensor 121-3. In addition, the area 189 is a front area in each depth information generated by the depth sensor 121-3, and is a behind area in the depth information generated by the depth sensor 121-1 and the depth sensor 121-2.

On the other hand, a gray area is a behind area in each depth information generated by the depth sensor 121-1 to the depth sensor 121-3.

In the case of the above-described method, an area in the object is identified as a behind area that is invisible from the viewpoint position 171. That is, as described above, in the depth information generated by any of the depth sensors 121, it can be estimated that an object is present in an area that is a behind area. Therefore, the geometry generation unit 131 specifies such an area as the object area 191 where the object exists.

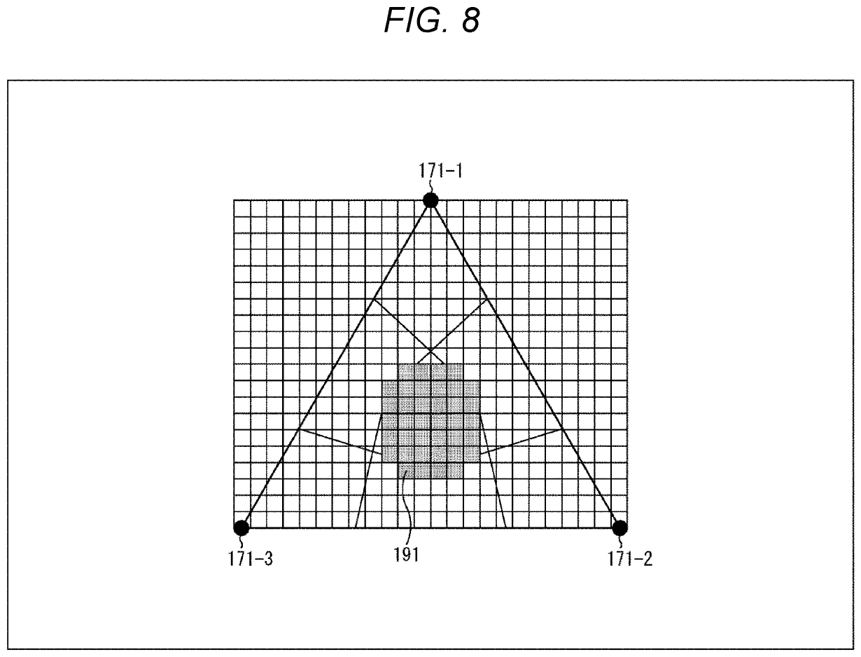

Note that the geometry generation unit 131 may specify the object area 191 on a voxel-by-voxel basis. For example, as illustrated in FIG. 8, the geometry generation unit 131 may divide the three-dimensional area into small areas of a predetermined size called voxels, and determine whether or not each voxel is the object area 191. With the above processing, the object area 191 can be specified more easily. Furthermore, the geometry can be quantized by performing the processing on a voxel basis. This makes it possible to suppress an increase in the amount of geometry data generated by the geometry generation unit 131.

Note that, in FIGS. 7 and 8, description will be made on a two-dimensional plane for convenience of description, but actually, since the depth is detected in the real space (three-dimensional area), the depth detection target range is a three-dimensional area.

Next, the geometry generation unit 131 specifies the position (coordinates) of the specified object area 191 in the three-dimensional area using each depth information. That is, the geometry generation unit 131 generates the geometry so that the object area 191 is represented by a point cloud. In other words, the geometry generation unit 131 generates the geometry of the object area using at least two pieces of depth information.

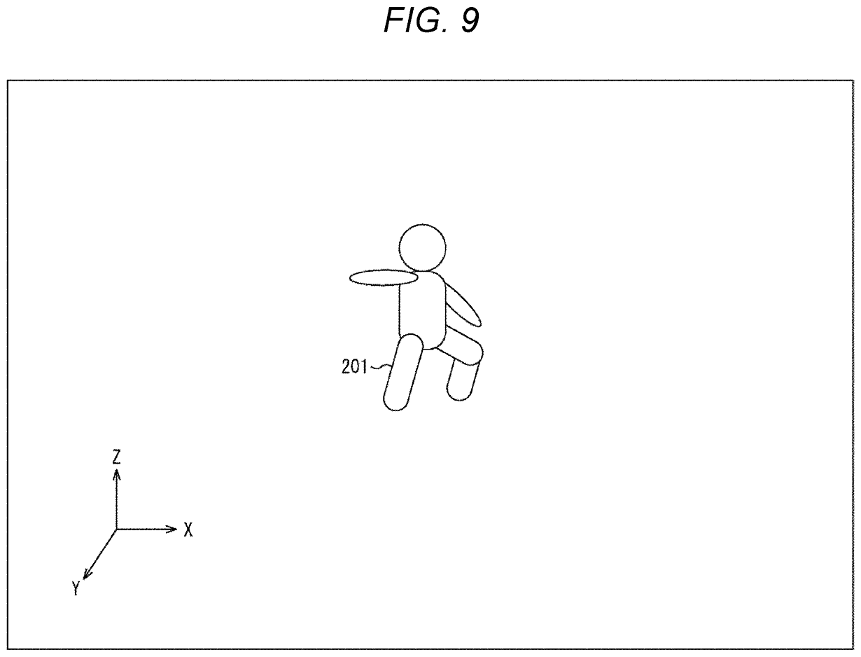

Geometry 201 shown in FIG. 9 shows an example of the geometry of an object 151 (FIG. 2). As illustrated in FIG. 9, geometry 201 is only positional information and does not include color information. The geometry 201 may be generated only for a surface of the object 151 or may also be generated for an interior of the object 151. That is, the point cloud representing the object 151 may include only points at positions on the surface of the object 151 or may include points at positions inside the object 151.

Note that, as described above, the depth information is information for each frame (information at a certain time). The geometry generation unit 131 generates geometry for each frame on the basis of the supplied depth information for each frame.

In a case where the depth sensor 121 detects the depth by, for example, the TOF method, the depth sensor 121 cannot detect the depth unless the depth sensor 121 can receive a reflected light. For example, in a portion of the depth detection target range where no object exists, the emitted light travels without being reflected by the object. That is, the depth sensor 121 cannot detect the depth of the portion. That is, the depth information may include a portion where the depth cannot be detected. Therefore, the geometry generation unit 131 may set the depth of the pixel whose depth has not been obtained, included in the depth information, to the farthest depth. That is, the geometry generation unit 131 may set the depth of the pixel whose depth is not detected to a maximum value that the depth can take. In this way, the geometry generation unit 131 can more easily identify the front area and the behind area.

For example, in a case where the depth sensor 121 measures the distance a plurality of times and detects the depth on the basis of the measurement results of the plurality of times, the depth sensor 121 can detect the depth with higher accuracy. However, in that case, the robustness against the motion of the object may be reduced. That is, in the depth information, the depth of a portion where the object has greatly moved cannot be obtained, and a so-called motion blur may occur. Therefore, the geometry generation unit 131 may duplicate the depth of peripheral pixels of a pixel whose depth cannot be acquired. In other words, the geometry generation unit 131 may set the depth of a pixel whose depth has not been obtained, included in the depth information to the same depth as peripheral pixels of that pixel.

For example, the motion blur occurs, and then since the portion is not included in the object area, the object area may be smaller than the shape of the object in the real space. Therefore, the geometry generation unit 131 sets the depth of the pixel where the motion blur occurs to be the same as the depth of the object area in the vicinity thereof. In this way, the object area reduced by the motion blur can be enlarged. That is, the geometry generation unit 131 can more stably specify the object area. In other words, the geometry generation unit 131 can improve robustness against the motion blur in the processing of specifying the object area.

The geometry generation unit 131 supplies the geometry and the depth information generated as described above to the attribute generation unit 132.

The attribute generation unit 132 performs processing related to generation of an attribute that is attribute information of each point of a point cloud. The content of the attribute information is arbitrary, but includes at least color information of each point. The attribute generation unit 132 acquires the geometry and the depth information supplied from the geometry generation unit 131.

Furthermore, the attribute generation unit 132 acquires the imaging information generated by each image sensor 122. The attribute generation unit 132 generates an attribute of the object area using the acquired captured image.

As described above, the detection unit 111 includes the plurality of image sensors 122. That is, the attribute generation unit 132 may generate the attribute using at least two captured images generated by each of the at least two image sensors 122.

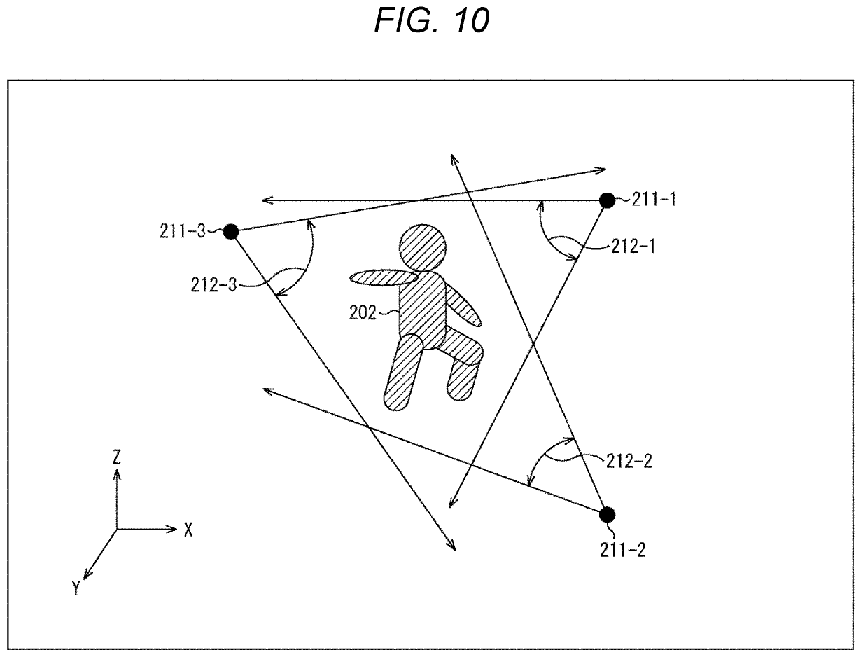

For example, as illustrated in FIG. 10, the attribute generation unit 132 associates the geometry with the attribute (color information) by projecting the color information of each pixel of the captured image onto the geometry 201 (FIG. 9) in the three-dimensional area.

At that time, the color information is projected in the position and direction in which each captured image is obtained in the three-dimensional area. That is, the attribute generation unit 132 projects the color information of each captured image in the same range as the imaging range.

In the case of the example of FIG. 10, the image sensor 122-1 images a range indicated by a double-headed arrow 212-1 from a viewpoint position 211-1 to generate a captured image. Therefore, the color information of the captured image is projected from the viewpoint position 211-1 toward the range indicated by the double-headed arrow 212-1. As a result, color information is added to a surface of the geometry 201 on a side facing the image sensor 122-1.

Similarly, the image sensor 122-2 images a range indicated by a double-headed arrow 212-2 from a viewpoint position 211-2 to generate a captured image. Therefore, the color information of the captured image is projected from the viewpoint position 211-2 toward the range indicated by the double-headed arrow 212-2. As a result, color information is added to a surface of the geometry 201 on a side facing the image sensor 122-2. Similarly, the image sensor 122-3 images a range indicated by a double-headed arrow 212-3 from a viewpoint position 211-3 to generate a captured image. Therefore, the color information of the captured image is projected from the viewpoint position 211-3 toward the range indicated by the double-headed arrow 212-3. As a result, color information is added to a surface of the geometry 201 on a side facing the image sensor 122-3.

Such coloring, that is, the association between the geometry and the attribute (color information) may be performed using the depth information and the captured image. As described above, each pixel of all the captured images corresponds to any pixel of any depth information. Furthermore, the geometry of each point corresponds to any pixel of any depth information. That is, the geometry and the color information can be associated with each other through the depth information. That is, the attribute generation unit 132 may specify a pixel of the captured image corresponding to the object area using the depth information, and associate the color information of the pixel with the geometry of the object as the attribute of the object. With the above processing, the geometry and the color information can be associated with higher accuracy.

Furthermore, the attribute generation unit 132 may correct the pixel misalignment between the depth information and the captured image and associate the color information with the geometry. For example, when mapping the color information to the 3D information, the attribute generation unit 132 may perform the mapping while correcting the deviation by applying color map optimization (CMO). With the above processing, more highly accurate 3D information (3D information in which an attribute is mapped with higher accuracy) can be obtained.

As described above, the attribute of each point representing the object 151 (FIG. 2) is generated. That is, the attribute 202 (FIG. 10) is generated.

Note that, as described above, the captured image and the geometry are information for each frame (information at a certain time). The attribute generation unit 132 generates an attribute for each frame on the basis of the supplied captured image and geometry of each frame.

Note that the captured image supplied from the image sensor 122 may be encoded. That is, the attribute generation unit 132 may acquire the coded data of the captured image. In that case, the attribute generation unit 132 decodes the coded data and generates (restores) an image. Then, the attribute generation unit 132 generates an attribute using the restored captured image. Note that this decoding method may be any method as long as the method is compatible with the encoding method applied by the image sensor 122. In other words, the attribute generation unit 132 decodes the coded data generated by each of the at least two image sensors 122, and generates the attribute using the obtained at least two captured images.

The attribute generation unit 132 supplies the geometry and the attribute (that is, 3D information for each frame) for each frame generated as described above to the time-series 3D information generation unit 113.

### Generation Processing of 3D Information for Each Frame

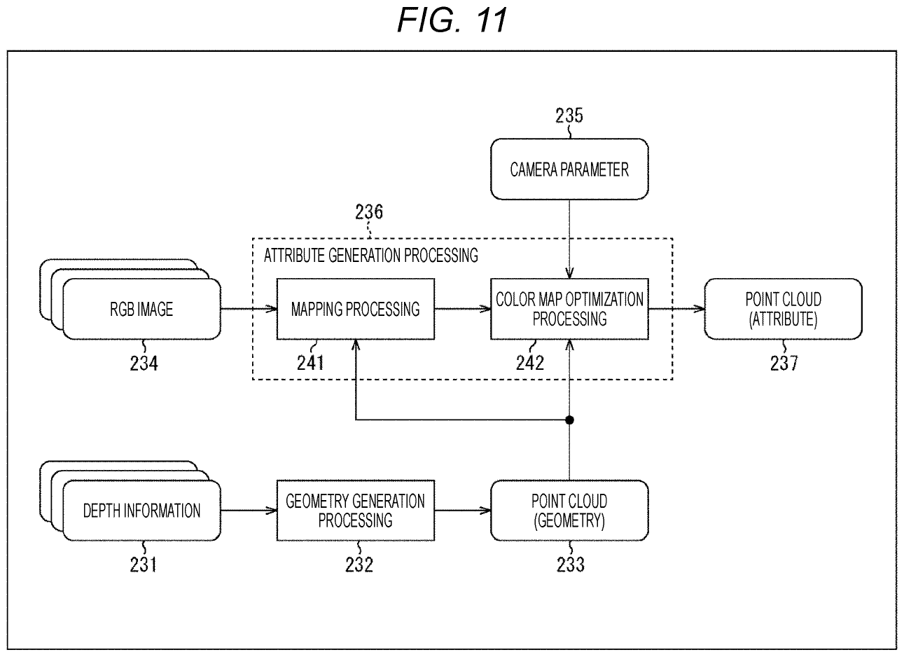

An outline of a flow of processing related to such generation of 3D information for each frame will be described with reference to FIG. 11.

First, geometry generation processing 232 is executed using the supplied depth information 231, and a geometry 233 of the point cloud is generated. Furthermore, an attribute generation processing 236 is executed using the geometry 233, and a supplied captured image (RGB image) 234, and a camera parameter 235 of the image sensor 122, and an attribute 237 of the point cloud are generated.

In the attribute generation processing 236, a mapping processing 241 of mapping the color information of the captured image 234 to the geometry 233 is executed using the geometry 233 and the captured image (RGB image) 234. Thereafter, color map optimization processing 242 for correcting the processing result of the mapping processing 241 is executed using the geometry 233 and the camera parameters 235, and the attribute 237 is generated.

Note that the 3D information generation processing for each frame as described above may be executed in parallel for a plurality of frames. With the above processing, the 3D information can be generated at a higher speed. For example, 3D information generation processing for 30 frames may be performed in parallel over one second to achieve a processing speed of 30 frames/second.

### Time-Series 3D Information Generation Unit

The time-series 3D information generation unit 113 executes processing related to generation of time-series 3D information that is time-series data. For example, the time-series 3D information generation unit 113 acquires the 3D information (geometry and attribute) for each frame supplied from the attribute generation unit 132. The time-series 3D information generation unit 113 generates the time-series 3D information by merging the 3D information for each frame including the geometry and the attribute for at least two frames. A method of this time sequencing is arbitrary. For example, Video-based Point Cloud Compression (V-PCC) of Moving Picture Experts Group (MPEG) or the like may be applied.

The time-series 3D information generation unit 113 supplies the generated time-series 3D information to the free viewpoint image display unit 114. For example, in a case where the free viewpoint image display unit 114 is configured as a device different from the time-series 3D information generation unit 113, the time-series 3D information generation unit 113 transmits the generated time-series 3D information to a device including the free viewpoint image display unit 114 as a destination. For example, transmission may be performed by a method similar to HLS (Http live streaming) or the like. As a data container, fMP4 (Fragmented MP4) or the like may be applied. A content delivery network (CDN) may be applied.

### Free Viewpoint Image Display Unit

The free viewpoint image display unit 114 acquires the time-series 3D information supplied from the time-series 3D information generation unit 113 and reproduces the time-series 3D information. For example, in a case where the free viewpoint image display unit 114 and the time-series 3D information generation unit 113 are configured as different devices, the free viewpoint image display unit 114 receives the time-series 3D information transmitted from the time-series 3D information generation unit 113. For example, the time-series 3D information may be transmitted as streaming delivery.

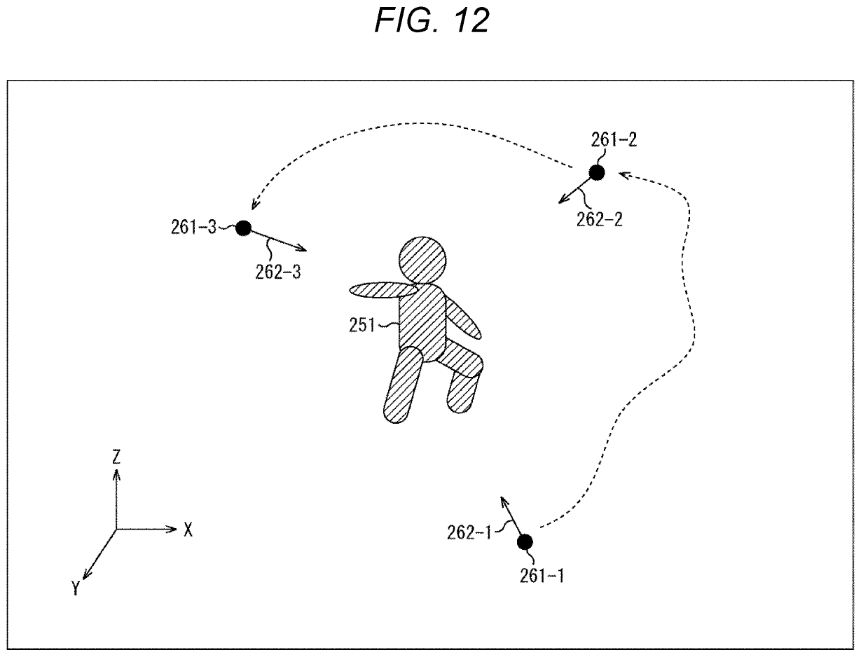

The free viewpoint image display unit 114 includes, for example, a headset such as a head-mounted display (HMD), and the like, and a display unit such as a smartphone, or a holographic display, and the like, and reproduces the time-series 3D information. At that time, the free viewpoint image display unit 114 can render 3D information at an arbitrary viewpoint. That is, the free viewpoint image display unit 114 can perform rendering according to a viewpoint position, a line-of-sight direction, or the like set by the user or the like, and generate and display a display image at the viewpoint. For example, as illustrated in FIG. 12, in a three-dimensional area including an object 251, the viewpoint position can be moved as indicated by a dotted arrow, or the line-of-sight direction can be changed. The free viewpoint image display unit 114 generates a display 2D image of each viewpoint according to such setting. Therefore, for example, the free viewpoint image display unit 114 can generate a 2D image in a case where the object 251 is viewed in a line-of-sight direction 262-1 from a viewpoint position 261-1, a 2D image in a case where the object 251 is viewed in a line-of-sight direction 262-2 from a viewpoint position 261-2, or a 2D image in a case where the object 251 is viewed in a line-of-sight direction 262-3 from a viewpoint position 261-3.

Such designation of the viewpoint position and the line-of-sight direction may be performed immediately (in real time). For example, while viewing the 2D image for display displayed on the free viewpoint image display unit 114, the user may input designation of the viewpoint position and the line-of-sight direction to the free viewpoint image display unit 114, and upon receiving the designation of the free viewpoint image display unit 114, the user may immediately generate and display a 2D image for display according to the designation.

As described above, with generation of the 3D information using not only the captured image but also the depth information, the information processing system 100 (frame 3D information generation unit 112) can generate the 3D information with higher accuracy.

Furthermore, a behind area that is invisible from the viewpoint position by the object is specified in the three-dimensional area on the basis of the depth information, at least two behind areas specified on the basis of each of at least two pieces of depth information are combined to specify an object area where the object exists in the three-dimensional area, and a geometry of the object area is generated using the at least two pieces of depth information, thereby making it possible to generate 3D information with higher accuracy.

That is, more accurate 3D information can be generated from fewer captured images. That is, this makes it possible to suppress an increase in the number of image sensors required to obtain sufficiently highly accurate 3D information, and makes it possible to suppress an increase in the cost required for imaging the real space. In addition, calibration can be performed more easily, and an increase in cost for calibration can be suppressed. Furthermore, since an increase in the load of the 3D information generation processing can be suppressed, an increase in the cost of the information processing device can be suppressed in order to generate sufficiently highly accurate 3D information.

That is, with application of the present technology, it is possible to suppress an increase in cost required for generating 3D information with sufficient accuracy and to generate the 3D information more easily.

### Flow of Processing of Entire System

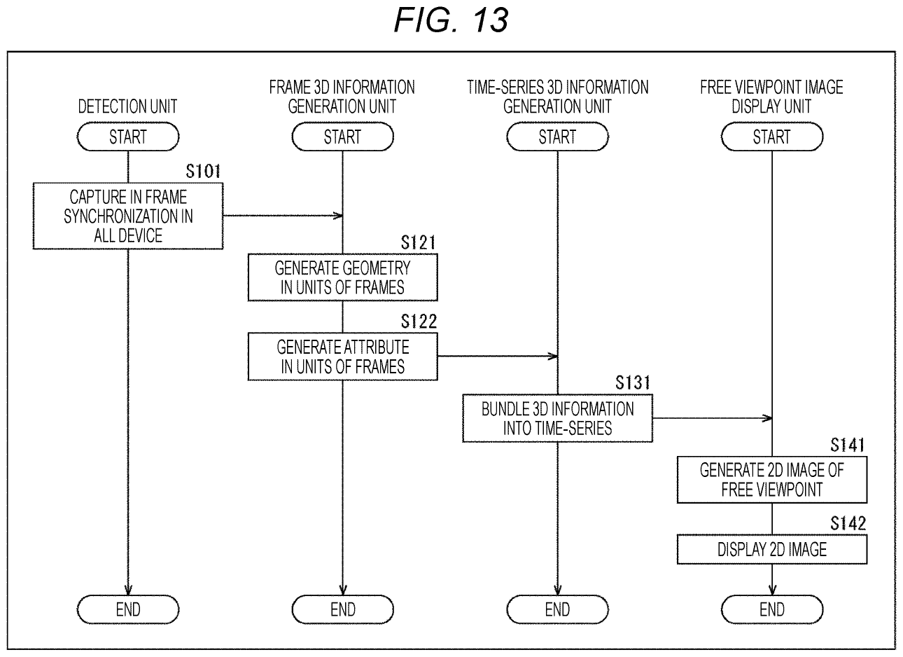

Next, an example of a flow of processing executed in the entire information processing system 100 will be described with reference to a flowchart of FIG. 13.

In Step S101, the detection unit 111 captures an image in frame synchronization in all the devices. That is, each depth sensor 121 and each image sensor 122 generate the depth information and the captured image in frame synchronization with each other. The detection unit 111 supplies the depth information and the captured image to the frame 3D information generation unit 112.

Upon acquiring the depth information and the captured image, the geometry generation unit 131 of the frame 3D information generation unit 112 generates the geometry in units of frames on the basis of the depth information in Step S121. At that time, the geometry generation unit 131 specifies a behind area that is invisible from the viewpoint position by the object in the three-dimensional area on the basis of the depth information, specifies an object area where the object exists in the three-dimensional area by combining at least two behind areas specified on the basis of at least two pieces of depth information in the three-dimensional area, and generates the geometry of the object area using the at least two pieces of depth information.

In Step S122, the attribute generation unit 132 generates an attribute in units of frames corresponding to the geometry of the object area by using the captured image or the like corresponding to the depth information. The frame 3D information generation unit 112 supplies the generated 3D information (geometry and attribute) for each frame to the time-series 3D information generation unit 113.

The time-series 3D information generation unit 113 acquires the 3D information for each frame, and then in Step S131, the time-series 3D information generation unit 113 generates time-series 3D information by bundling the 3D information of two or more frames into time-series data. The time-series 3D information generation unit 113 supplies the generated time-series 3D information to the free viewpoint image display unit 114.

Upon acquiring the time-series 3D information, the free viewpoint image display unit 114 renders the 3D information and generates a 2D image of a free viewpoint in Step S141. Then, in Step S142, the free viewpoint image display unit 114 displays the 2D image.

With execution of each processing as described above, the information processing system 100 can suppress an increase in cost required for generating the 3D information with sufficient accuracy, and can more easily generate the 3D information.

### 3. Second Embodiment

### Information Processing System

Each processing unit of the information processing system 100 described with reference to FIG. 1 may be configured as an arbitrary device. For example, one processing unit may be configured as one device, or a plurality of processing units may be configured as one device.

For example, each of the depth sensors 121 may be a different device. The plurality of depth sensors 121 may be configured as one device. Furthermore, the image sensors 122 may be different from each other. The plurality of image sensors 122 may be configured as one device. Further, the depth sensor 121 and the image sensor 122 may be configured as one device. In that case, the number of depth sensors 121 and the number of image sensors 122 each configured as one device are arbitrary. For example, the number of depth sensors 121 and the number of image sensors 122 configured as one device may be the same, or one may be more than the other.

Furthermore, the detection unit 111 and the frame 3D information generation unit 112 may be configured as one device. For example, the depth sensor 121 and the geometry generation unit 131 may be configured as one device. Furthermore, the image sensor 122 and the attribute generation unit 132 may be configured as one device. The depth sensor 121, the image sensor 122, the geometry generation unit 131, and the attribute generation unit 132 may be configured as one device. Of course, the detection unit 111 and the frame 3D information generation unit 112 may be configured as different devices.

Furthermore, the frame 3D information generation unit 112 and the time-series 3D information generation unit 113 may be configured as one device. Furthermore, the frame 3D information generation unit 112 and the time-series 3D information generation unit 113 may be configured as different devices.

Furthermore, the time-series 3D information generation unit 113 and the free viewpoint image display unit 114 may be configured as one device. Furthermore, the time-series 3D information generation unit 113 and the free viewpoint image display unit 114 may be configured as different devices.

Furthermore, the detection unit 111, the frame 3D information generation unit 112, and the time-series 3D information generation unit 113 may be configured as one device. Furthermore, the detection unit 111, the frame 3D information generation unit 112, the time-series 3D information generation unit 113, and the free viewpoint image display unit 114 may be configured as one device.

Note that each processing unit of the detection unit 111 to the free viewpoint image display unit 114 can be realized as an arbitrary device or system. For example, each of these processing units may be realized as a server (including a cloud server) or may be realized as a client (information processing terminal device).

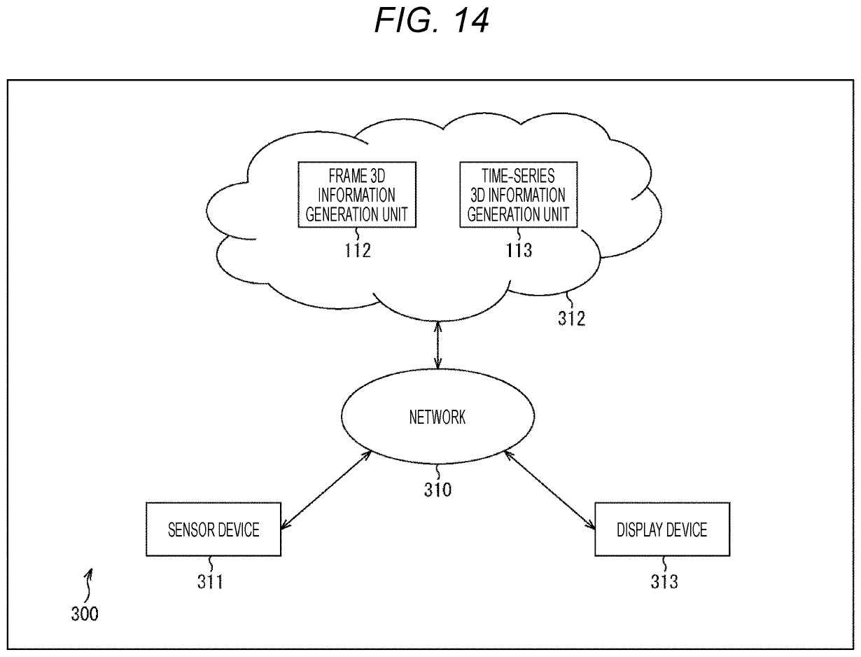

For example, the information processing system 100 may be realized as a configuration as illustrated in FIG. 14.

An information processing system 300 illustrated in FIG. 14 includes a sensor device 311, a cloud server 312, and a display device 313 that are communicably connected to each other through a network 310.

The network 310 may include any communication network such as the Internet and the like. The sensor device 311 includes a detection unit 111 and detects desired information in the real space. That is, the sensor device 311 includes at least two depth sensors 121 and at least two image sensors 122, and detects information including at least two pieces of depth information and at least two captured images. The sensor device 311 supplies the detected information to the cloud server 312.

The cloud server 312 is a server that performs information processing with an arbitrary physical configuration. The cloud server 312 implements the functions of the frame 3D information generation unit 112 and the time-series 3D information generation unit 113. That is, the cloud server 312 generates 3D information for each frame on the basis of the information supplied from the sensor device 311, and further generates time-series 3D information by bundling a plurality of frames of the 3D information. The cloud server 312 provides the 3D information to the display device 313 by, for example, streaming distribution or the like.

Upon acquiring the time-series 3D information through the network 310, the display device 313 uses the time-series 3D information to generate and display 2D images for display corresponding to the viewpoint position, the viewpoint direction, and the like designated by the user or the like.

In the information processing system 300 having such a configuration, the cloud server 312 generates the 3D information using the depth information and the image information, similarly to the case of the information processing system 100. Also, at that time, the cloud server 312 specifies a behind area that is invisible from the viewpoint position by the object in the three-dimensional area on the basis of the depth information, specifies an object area where the object exists in the three-dimensional area by combining at least two behind areas specified on the basis of at least two pieces of depth information in the three-dimensional area, and generates the geometry of the object area using the at least two pieces of depth information.

In this way, as in the case of the information processing system 100, the information processing system 300 can suppress an increase in cost required for generating the 3D information with sufficient accuracy, and can generate the 3D information more easily.

### 4. Appendix

### Computer

The above-described series of processing can be executed by hardware or software. In a case where a series of processing is executed by software, a program included in the software is installed on a computer. Here, the computer includes a computer incorporated in dedicated hardware, a general-purpose personal computer capable of executing various functions by installing various programs, and the like, for example.

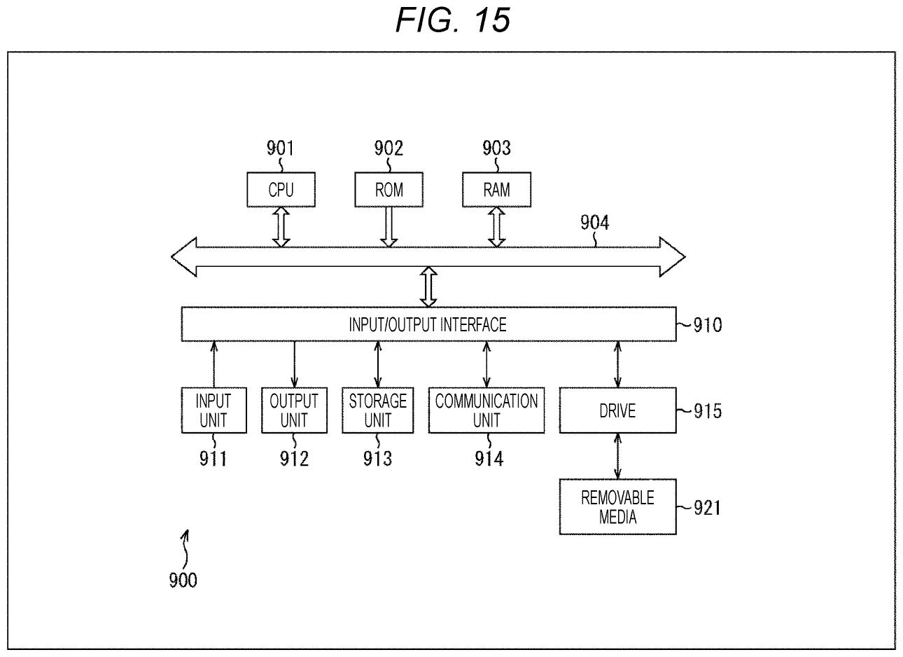

FIG. 15 is a block diagram illustrating a configuration example of hardware of a computer that executes the above-described series of processing by a program.

In a computer 900 illustrated in FIG. 15, a central processing unit (CPU) 901, a read only memory (ROM) 902, and a random access memory (RAM) 903 are interconnected through a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a non-volatile memory and the like. The communication unit 914 includes, for example, a network interface. The drive 915 drives a removable medium 921 such as a magnetic disk, an optical disk, a magneto-optical disk, or a semiconductor memory.

In the computer configured as described above, the series of processing described above is executed, for example, by the CPU 901 loading a program stored in the storage unit 913 into the RAM 903 through the input/output interface 910 and the bus 904, and executing the program. Furthermore, the RAM 903 also appropriately stores data and the like necessary for the CPU 901 to execute various types of processing.

A program executed by the computer can be applied by being recorded on the removable medium 921 as a package medium, or the like, for example. In this case, the program can be installed in the storage unit 913 through the input/output interface 910 by attaching the removable medium 921 to the drive 915.

Furthermore, the program can also be provided through a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

### Applicable Target of Present Technology

The present technology may be applied to any configuration. For example, the present technology may be applied to various electronic devices.

Furthermore, for example, the present technology can also be implemented as a partial configuration of a device, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of devices. For example, the present technology may be implemented as cloud computing shared and processed in cooperation by a plurality of devices through a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (devices, modules (parts) and the like), and it does not matter whether or not all the components are in the same housing. Therefore, a plurality of devices stored in different housings and connected over a network, and a single device including a plurality of modules stored in one housing are both regarded as systems.

### Field and Application to Which Present Technology is Applicable

The system, device, processing unit and the like to which the present technology is applied can be used in any field such as traffic, medical care, crime prevention, agriculture, livestock industry, mining, beauty care, factory, household appliance, weather, and natural surveillance, for example. Furthermore, application thereof is also arbitrary.

### Others

Note that, in the present specification, various kinds of information (such as metadata) related to coded data (a bitstream) may be transmitted or recorded in any form as long as it is associated with the coded data. Here, the term “associating” means, when processing one data, allowing other data to be used (to be linked), for example. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to combine a plurality of objects into one, such as to combine coded data and metadata into one data, and mean one method of “associating” described above.

Furthermore, the embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, when the configuration and operation as the entire system are substantially the same, a part of the configuration of a certain device (or processing unit) may be included in the configuration of another device (or another processing unit).

Furthermore, for example, the above-described programs may be executed in an arbitrary device. In this case, the device is only required to have a necessary function (functional block and the like) and obtain necessary information.

Furthermore, for example, each step in one flowchart may be executed by one device, or may be executed by being shared by a plurality of devices. Moreover, in a case where a plurality of pieces of processing is included in one step, the plurality of pieces of processing may be executed by one device, or may be shared and executed by a plurality of devices. In other words, a plurality of pieces of processing included in one step can be executed as a plurality of steps. Conversely, the processes described as the plurality of the steps can also be collectively executed as one Step.

Furthermore, the program executed by the computer may have the following features. For example, the pieces of processing of the steps describing the program may be executed in time series in the order described in the present specification. Furthermore, the pieces of processing of the steps describing the program may be executed in parallel. Moreover, the pieces of processing of the steps describing the program may be individually executed at the necessary timing, such as when the program is called. That is, the pieces of processing of the respective steps may be executed in an order different from the above-described order as long as there is no contradiction. Furthermore, the pieces of processing of steps describing this program may be executed in parallel with the pieces of processing of another program. Moreover, the pieces of processing of the steps describing this program may be executed in combination with the pieces of processing of another program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology may also have the following configurations.
(1) An information processing device including:
a geometry generation unit that specifies a behind area that is invisible from a viewpoint position by an object in a three-dimensional area on the basis of depth information, specifies an object area where the object exists in the three-dimensional area by combining at least two of the behind areas specified on the basis of each of at least two pieces of the depth information, and generates a geometry of the object area using the at least two pieces of depth information; and
an attribute generation unit that generates an attribute of the object area using a captured image corresponding to the depth information.
(2) The information processing device according to (1), in which
the geometry generation unit sets a depth of a pixel whose depth is not obtained, included in the depth information, to a farthest depth.
3) The information processing device according to (1), in which
the geometry generation unit sets a depth of a pixel whose depth is not obtained, included in the depth information to the same depth as peripheral pixels of the pixel.
(4) The information processing device according to any one of (1) to (3), in which
the attribute generation unit specifies a pixel of the captured image corresponding to the object area using the depth information, and associates color information of the pixel with the geometry of the object as the attribute of the object.
(5) The information processing device according to (4), in which
the attribute generation unit corrects a pixel misalignment between the depth information and the captured image and associates the color information with the geometry.
(6) The information processing device according to any one of (1) to (5), further including
a time-series 3D information generation unit that generates time-series 3D information that is time-series data, in which
the geometry generation unit generates the geometry for each frame,
the attribute generation unit generates the attribute for each frame, and
the time-series 3D information generation unit generates the time-series 3D information by merging 3D information for each frame including the geometry and the attribute for at least two frames.
(7) The information processing device according to (6), in which
the time-series 3D information generation unit transmits the generated time-series 3D information.
(8) The information processing device according to any one of (1) to (7), further including
at least two depth detection units that generate the depth information by performing distance measurement in the three-dimensional area, in which
the geometry generation unit generates the geometry using the at least two pieces of depth information generated by each of the at least two depth detection units.
(9) The information processing device according to (8), in which
the depth detection unit encodes the generated depth information to generate coded data, and
the geometry generation unit decodes the coded data generated by each of the at least two depth detection units, and generates the geometry using the obtained at least two pieces of depth information.
(10) The information processing device according to (8) or (9), in which
the depth detection unit quantizes the generated depth information, and
the geometry generation unit generates the geometry using the quantized depth information generated by each of the at least two depth detection units.
(11) The information processing device according to any one of (1) to (10), further including
at least two imaging units that generate the captured image by imaging a subject in the three-dimensional area, in which
the attribute generation unit generates the attribute using at least two of the captured images generated by each of the at least two imaging units.
(12) The information processing device according to (11), in which
the imaging unit encodes the generated captured image to generate coded data, and
the attribute generation unit decodes the coded data generated by each of the at least two of the imaging units, and generates the attribute using the obtained the at least two captured images.
(13) An information processing method including:
specifying a behind area that is invisible from a viewpoint position by an object in a three-dimensional area on the basis of depth information, specifying an object area where the object exists in the three-dimensional area by combining at least two of the behind areas specified on the basis of each of at least two pieces of the depth information, and generating a geometry of the object area using the at least two pieces of depth information; and
generating an attribute of the object area using a captured image corresponding to the depth information.

### REFERENCE SIGNS LIST

100 Information processing system
111 Detection unit
112 Frame 3D information generation unit
113 Time-series 3D information generation unit
114 Free viewpoint image display unit
121 Depth sensor
122 Image sensor
131 Geometry generation unit
132 Attribute generation unit
300 Information processing system
310 Network
311 Sensor device
312 Cloud server
313 Display device
900 Computer

1. An information processing device comprising:
a geometry generation unit that specifies a behind area that is invisible from a viewpoint position by an object in a three-dimensional area on a basis of depth information, specifies an object area where the object exists in the three-dimensional area by combining at least two of the behind areas specified on a basis of each of at least two pieces of the depth information, and generates a geometry of the object area using the at least two pieces of depth information; and
an attribute generation unit that generates an attribute of the object area using a captured image corresponding to the depth information.

2. The information processing device according to claim 1, wherein
the geometry generation unit sets a depth of a pixel whose depth is not obtained, included in the depth information, to a farthest depth.

3. The information processing device according to claim 1, wherein
the geometry generation unit sets a depth of a pixel whose depth is not obtained, included in the depth information to the same depth as peripheral pixels of the pixel.

4. The information processing device according to claim 1, wherein
the attribute generation unit specifies a pixel of the captured image corresponding to the object area using the depth information, and associates color information of the pixel with the geometry of the object as the attribute of the object.

5. The information processing device according to claim 4, wherein
the attribute generation unit corrects a pixel misalignment between the depth information and the captured image and associates the color information with the geometry.

6. £ The information processing device according to claim 1, further comprising
a time-series 3D information generation unit that generates time-series 3D information that is time-series data, wherein
the geometry generation unit generates the geometry for each frame,
the attribute generation unit generates the attribute for each frame, and
the time-series 3D information generation unit generates the time-series 3D information by merging 3D information for each frame including the geometry and the attribute for at least two frames.

7. The information processing device according to claim 6, wherein
the time-series 3D information generation unit transmits the generated time-series 3D information.

8. The information processing device according to claim 1, further comprising
at least two depth detection units that generate the depth information by performing distance measurement in the three-dimensional area, wherein
the geometry generation unit generates the geometry using the at least two pieces of depth information generated by each of the at least two depth detection units.

9. The information processing device according to claim 8, wherein
the depth detection unit encodes the generated depth information to generate coded data, and
the geometry generation unit decodes the coded data generated by each of the at least two depth detection units, and generates the geometry using the obtained at least two pieces of depth information.

10. The information processing device according to claim 8, wherein
the depth detection unit quantizes the generated depth information, and
the geometry generation unit generates the geometry using the quantized depth information generated by each of the at least two depth detection units.

11. The information processing device according to claim 1, further comprising
at least two imaging units that generate the captured image by imaging a subject in the three-dimensional area, wherein
the attribute generation unit generates the attribute using at least two of the captured images generated by each of the at least two imaging units.

12. The information processing device according to claim 11, wherein
the imaging unit encodes the generated captured image to generate coded data, and
the attribute generation unit decodes the coded data generated by each of the at least two of the imaging units, and generates the attribute using the obtained the at least two captured images.

13. An information processing method comprising:
specifying a behind area that is invisible from a viewpoint position by an object in a three-dimensional area on a basis of depth information, specifying an object area where the object exists in the three-dimensional area by combining at least two of the behind areas specified on a basis of each of at least two pieces of the depth information, and generating a geometry of the object area using the at least two pieces of depth information; and
generating an attribute of the object area using a captured image corresponding to the depth information.
